(19) United States
(12) Patent Application Publication
(10) Pub. No.: US 2018/0111366 A1
(43) Pub. Date: Apr. 26, 2018

(54) ENVIRONMENTAL CONTROL OF A LASER IMAGING MODULE (LIM) TO REDUCE A DIGITAL MICROMIRROR (DMD) OPERATING TEMPERATURE

(71) Applicant: Xerox Corporation, Norwalk, CT (US)

(72) Inventors: Mark A. Adiletta, Fairport, NY (US); Christopher D. Atwood, Rochester, NY (US); Ali R. Dergham, Fairport, NY (US); Roger G. Leighton, Hilton, NY (US); Francisco Zirilli, Fairport, NY (US)

(73) Assignee: Xerox Corporation

(21) Appl. No.: 15/299,850

(22) Filed: Oct. 21, 2016

(51) Int. Cl. B41F 23/04; G02B 7/00; G02B 26/08; G02B 27/00

(52) U.S. Cl. CPC B41F 23/04; G02B 27/0006; G02B 26/0833; G02B 7/008

(57) ABSTRACT

An environmental control system includes a heat exchanger and a desiccant dehumidifier, and a laser imaging module that includes one or more digital micromirror devices and one or more laser diode units. The heat exchanger reduces the temperature of the air to be delivered to the laser imaging module, wherein prior to the air entering the laser imaging module, the air passes through the desiccant dehumidifier, which dries the air to a lower relative humidity so as to reduce the environmental relative humidity to prevent condensation on critical components within the laser imaging module such as the digital micromirror devices and the laser diode units.

### TECHNICAL FIELD

Embodiments are generally related to the field of laser imaging. Embodiments also relate to thermochromic ink printing and digital laser imaging. Embodiments further relate to LIM (Laser Imaging Module), laser diode arrays, and DMD (Digital Micromirror Device) technologies. Embodiments further relate to systems and devices for reducing the operating temperature of an LIM and/or its components such as a DMD.

### BACKGROUND

High power laser imaging is increasingly being employed in modern printing operations. One example of a laser imaging technique used in these operations is offset lithography, which is a method utilized in modern printing operations. (Note that for the purpose hereof, the terms “printing” and “marking” are interchangeable.) In a typical lithographic process, a printing plate (i.e., which may be a flat plate, the surface of a cylinder, belt, etc.) can be configured with “image regions” formed of, for example, hydrophobic and oleophilic material, and “non-image regions” formed of a hydrophilic material. Such image regions correspond to the areas on the final print (i.e., the target substrate) that are occupied by a printing or a marking material such as ink, whereas the non-image regions correspond to the areas on the final print that are not occupied by the marking material.

Variable data lithography (also referred to as digital lithography or digital offset) utilized in printing processes begins with a fountain solution that dampens a silicone imaging plate on an imaging drum. The fountain solution forms a film on the silicone plate that is on the order of approximately one (1) micron thick. The drum rotates to an “exposure” station where a high power laser imager is utilized to remove the fountain solution at the locations where the image pixels are to be formed. This forms a fountain solution based “latent image.” The drum then further rotates to a “development” station where lithographic-like ink is brought into contact with the fountain solution based “latent image” and ink “develops” onto the places where the laser has removed the fountain solution. The ink is hydrophobic. An ultra violet (UV) light may be applied so that photo-initiators in the ink may partially cure the ink to prepare it for high efficiency transfer to a print media such as paper. The drum then rotates to a transfer station where the ink is transferred to a printing media such as paper. The silicone plate is compliant, so an offset blanket is not used to aid transfer. UV light may be applied to the paper with ink to fully cure the ink on the paper. The ink is on the order of one (1) micron pile height on the paper.

The formation of the image on the printing plate can be accomplished with imaging modules. Each module can utilize a linear output high power infrared (IR) laser to illuminate a digital light projector (DLP) multi-mirror array, also referred to as the “DMD” (Digital Micromirror Device). The mirror array is similar to what is commonly used in computer projectors and some televisions. The laser provides constant illumination to the mirror array. The mirror array deflects individual mirrors to form the pixels on the image plane to pixel-wise evaporate the fountain solution on the silicone plate. If a pixel is not to be turned on, the mirrors for that pixel defied such that the laser illumination for that pixel does not hit the silicone surface, but goes into a chilled light dump heat sink.

A single laser and mirror array can form an imaging module that provides imaging capability for approximately one (1) inch in the cross-process direction. Thus, a single imaging module simultaneously images a one (1) inch by one (1) pixel line of the image for a given scan line. At the next scan line, the imaging module images the next one (1) inch by one (1) pixel line segment. By using several imaging modules composed of several lasers and several mirror-arrays, butted together, an imaging function for a very wide cross-process width can be achieved.

One non-limiting example of a DMD system utilized in the context of a lithographic application is disclosed in U.S. Pat. No. 8,508,791 entitled “Image feedforward laser power control for a multi-mirror based high power imager” which issued to Peter Paul, et al. on Aug. 13, 2013, and is assigned to Xerox Corporation of Norwalk, Conn. U.S. Pat. No. 8,508,791 is incorporated herein by reference in entirety.

The use of DMDs for high power laser imaging creates unique cooling challenges. Due to the high heat fluxes involved, novel cooling methods need to be implemented. In liquid cooling using conventional cooling channels, a mixture of water and ethylene-glycol is commonly used. Due to the DMD mounting on the electrical board, however, the space available to provide effective cooling is very limited. As a result, a simple straight through transport of the coolant through a channel is not very effective in providing the required heat removal.

Also, the DMD components mainly have a low thermal conductivity, which impedes the transfer of heat to the cooling channel. The heat flux at the surface plane of the mirrors varies with location, reaching a maximum of, for example, 44.5 W/cm² and the amount of energy absorbed at the substrate below the mirrors is of the same order of magnitude at, for example, 46.9 W/cm². The cooling flow temperature requirements (e.g., 5° C. to 15° C.) can also create another issue with condensation on critical components such as the DMD and laser diode units depending on the LIM operating environment temperature and humidity.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for a system for cooling an LIM and its components such as a DMD.

It is another aspect of the disclosed embodiments to provide or an environmental cooling system for an LIM that combines a cooling fluid and a low relative-humidity chilled air flow to cool the DMD in the LIM.

The aforementioned aspects and other objectives and advantages can now be achieved as described herein. In an example embodiment, an environmental control system can be implemented, which includes a heat exchanger and a desiccant dehumidifier, and an LIM that includes one or more digital micromirror devices and one or more laser diode units. The heat exchanger reduces the temperature of the air to be delivered to the laser imaging module, wherein prior to the air entering the laser imaging module, the air passes through the desiccant dehumidifier, which dries the air to a lower relative humidity so as to reduce the environmental relative humidity to prevent condensation on critical components within the laser imaging module such as the digital micromirror devices and the laser diode units.

Such an environmental control system thus reduces the local environmental operating temperature of the Laser Imaging Module (LIM) to enhance heat transfer from the Digital Micromirror Device (DMD), and additionally reduces the environmental relative humidity to prevent condensation on critical components within the LIM such as the DMD and the laser diode units. The environmental control system can include a fluid-to-air compact heat exchanger to reduce the temperature of the air to be delivered to the LIM. Before the cold air enters the LIM passes through a Desiccant Dehumidification System (i.e., desiccant dehumidifier), which dries the air to an even lower relative humidity. The amount of dehumidification required depends on the local environmental conditions and the DMD cooling flow temperature.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a pictorial diagram that depicts a portion of a DMD system that includes a DMD located on a circuit board in association with a corresponding cooling system that includes a cooling flow out portion and a cooling flow in portion 18, in accordance with an example embodiment;

FIG. 2 illustrates a pictorial diagram detailing an underside view of a contact region between the DMD shown in FIG. 1 and the cooling system in accordance with an example embodiment;

FIG. 3 illustrates a pictorial view of a cooling system including a liquid cooling path for a “straight through” design, in accordance with an example embodiment;

FIGS. 4-5 illustrate pictorial diagrams demonstrating the thermal conductivity of each component of the DMD, in accordance with an example embodiment;

FIGS. 6A-6C to 7A-70 illustrate a group of pictorial diagrams and graphs depicting the temperature distribution of the mirrors and the substrate for the conditions shown in the figure, in accordance with an example embodiment;

FIGS. 8-9 illustrate the layout of an LIM assembly with and without the front cover respectively, in accordance with an example embodiment;

FIG. 10 illustrates a pictorial diagram depicting the location of the DMD within the LIM assembly, in accordance with an example embodiment;

FIG. 11 illustrates a schematic diagram of an environmental control system for temperature and humidity control, in accordance with an example embodiment and

FIG. 12 illustrates a desiccant dehumidification system that can be implemented in accordance with an example embodiment.

### DETAILED DESCRIPTION

The particular values and configurations discussed in these non-limiting examples can be varied and are cited merely to illustrate one or more embodiments and are not intended to limit the scope thereof.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be interpreted in a limiting sense.

Throughout the specification and claims, terms may have nuanced meanings suggested or implied in context beyond an explicitly stated meaning. Likewise, phrases such as “in one embodiment” or “in an example embodiment” and variations thereof as utilized herein do not necessarily refer to the same embodiment and the phrase “in another embodiment” or “in another example embodiment” and variations thereof as utilized herein may or may not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a,” “an,” or “the”, again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

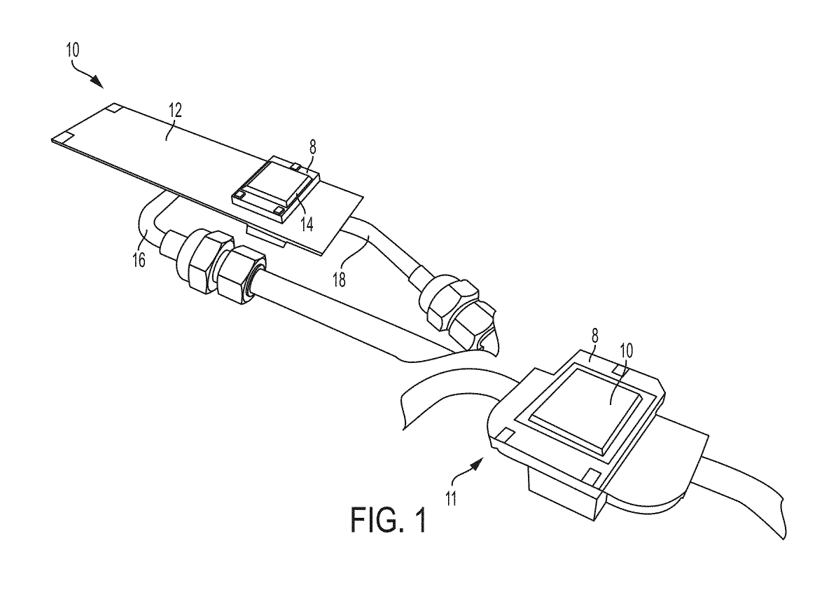

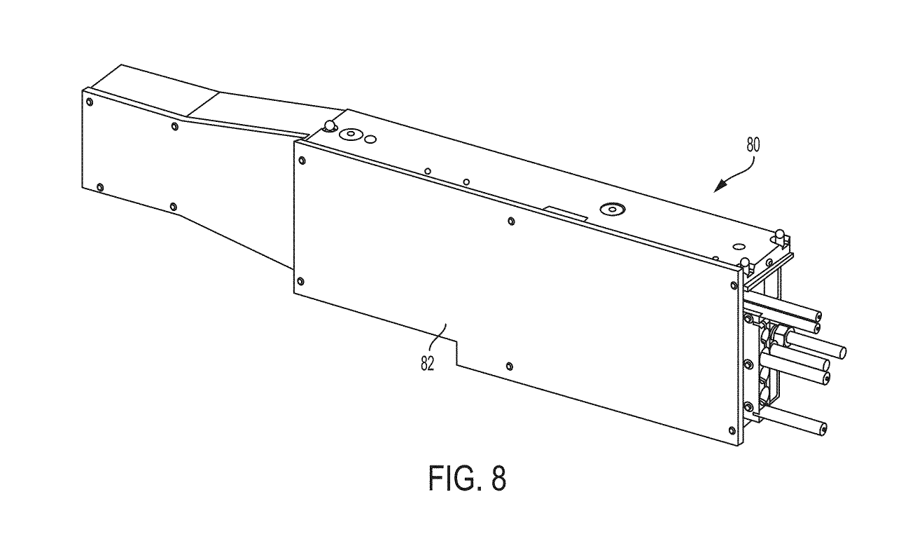

FIG. 1 illustrates a pictorial diagram that depicts a portion of a DMD system 10 that includes a DMD 14 located on a circuit board 12 in association with a corresponding cooling system that includes a cooling flow out tube 16 and a cooling flow in tube 18, in accordance with an example embodiment. The DMD 14 is supported by a DMD housing 8 as shown in FIG. 8. FIG. 1 further depicts a close up portion 11 of the DMD system 10, with the board 12 shown removed for clarity. The close portion 11 is shown in the lower right hand side of FIG. 1 and the larger portion of the DMD system 10 is shown in the upper left hand side of FIG. 1. Thus, FIG. 1 shows some detail of the mounting of the DMD 14 on the circuit board 12 and the corresponding cooling system.

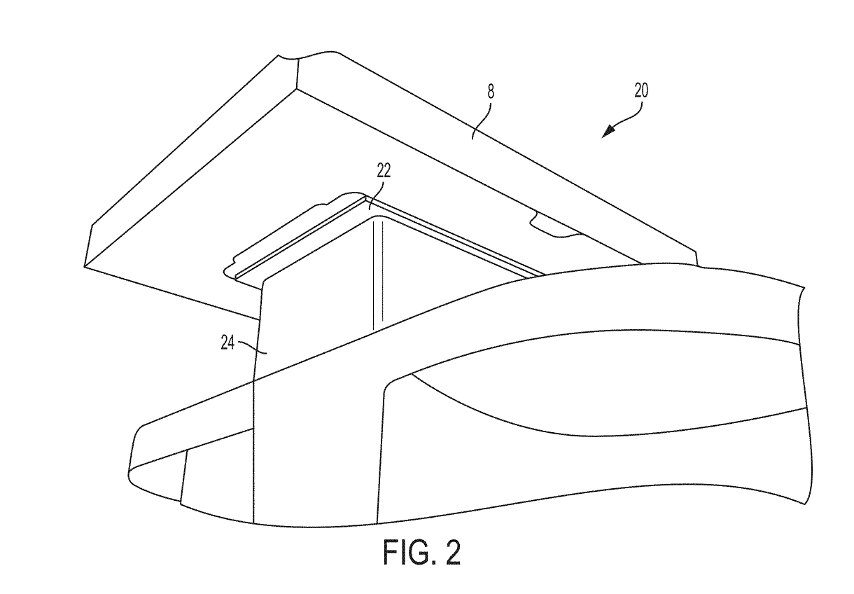

FIG. 2 illustrates a pictorial diagram detailing the underside view 20 of the contact region between the DMD 14 shown in FIG. 1 and the cooling system, in accordance with an example embodiment. FIG. 2 thus shows the underside view 20 of the DMD 14 and a cooling jacket 24. The DMD plug-in socket has been removed from FIG. 2 for clarity. The cooling system thus can include the cooling jacket 24 and a thermal pad 22.

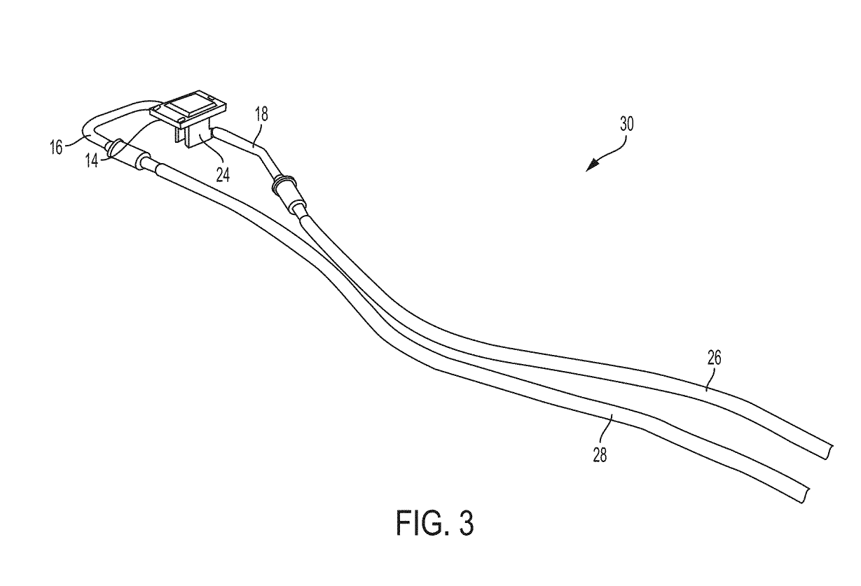

FIG. 3 illustrates a pictorial view of a cooling system 30 including a liquid cooling path for a “straight through” design, in accordance with an example embodiment. The cooling system 30 can include cooling components such as the cooling jacket 24 shown in both FIG. 2 and FIG. 3, and the thermal pad 22 shown in FIG. 2 (but not shown in FIG. 3). The cooling system 30 further includes a cooling loop domain outlet flow 28 and a cooling loop fluid domain inlet flow 26. The cooling loop domain outlet flow 28 connects with the cooling flow out tube 16 shown in both FIG. 1 and FIG. 3. Similarly, the cooling loop fluid domain inlet flow 26 is operably connected to the cooling flow in tube 18 shown in both FIG. 1 and FIG. 3.

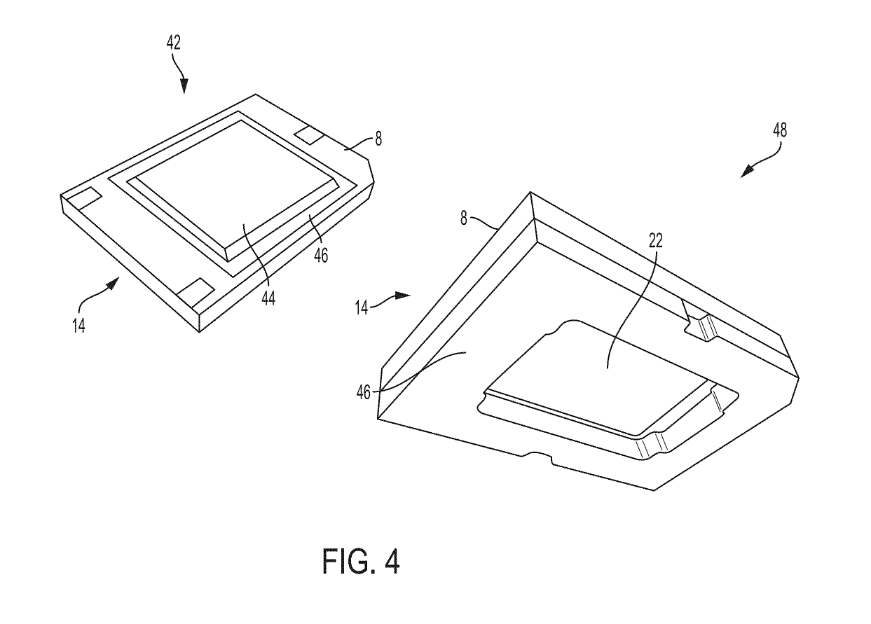

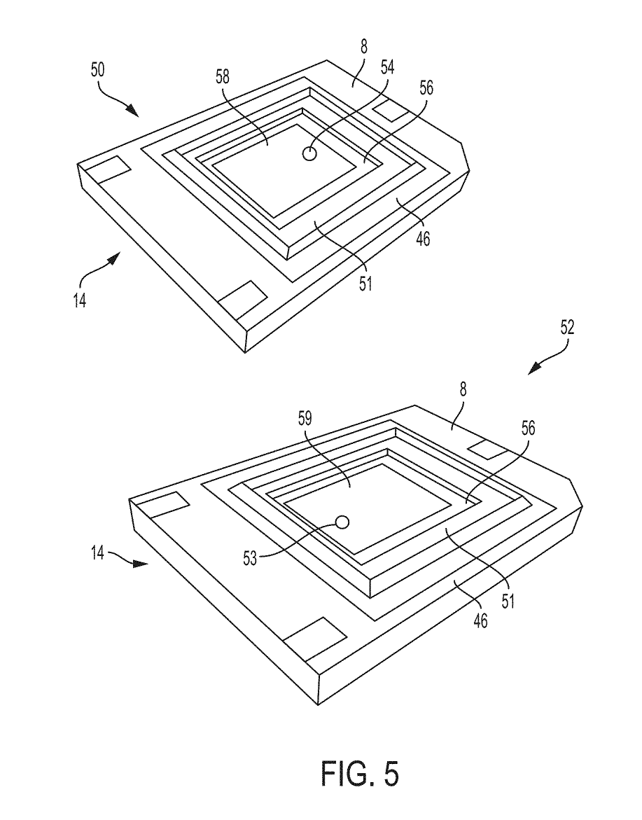

FIGS. 4-5 illustrate respective top and bottom views 42 and 48 and perspective views 50 and 52 demonstrating the thermal conductivity of each component of the DMD 14, in accordance with an example embodiment. For example, the top view 42 shown at the top left hand side of FIG. 4 shows the DMD 14 with a DMD window 44, which can be configured from glass having a thermal conductivity of, for example, k_{glass}=1.2 W/m-K; a DMD epoxy 46 that can be configured from an epoxy having a thermal conductivity of, for example, k_{epoxy}=0.854 W/m-K and the DMD housing 8 configured from alumina having a thermal conductivity of, for example, kₐₗᵤₘᵢₙₐ=30 W/m-K. The underside or bottom view 48 shown at the lower right hand side of FIG. 4 shows the DMD 14 as having a DMD socket configured from plastic and having, for example, a thermal conductivity of K_{plastic}=0.63 W/m-K; and the thermal pad 22 configured from indium and having an example thermal conductivity of k_{inidum}=86 W/m-K.

FIG. 5 shows the two different side perspective views 50 and 52 of the DMD 14. In view 50, the DMD 14 is shown with the DMD epoxy 46, the DMD housing 8, a mirrors-to-substrate gap 54, a DMD silicon substrate 56, a DMD bezzel 51, and a DMD mirrors surface interface 58. The DMD window 44 and the DMD socket shown in FIG. 4 are removed in both views 50, 52 for clarity. The DMD bezzel 51 can be configured from glass and may have a thermal conductivity of, for example, k_{glass}=1.2 W/m-K. The DMD silicon substrate 56 in some example embodiments may have a thermal conductivity of k_{silicon}=149.0 W/m-K. The mirrors-to-substrate gap in some example embodiments may have a thickness of 1.6 μm and a thermal conductivity of 0.0438 W/m-K. The side perspective view 52 shown at the bottom right hand side of FIG. 5 depicts the DMD 14 as further including not only the DMD bezzel 51, the DMD epoxy 46, and so on, but also a DMD substrate interface 59 and a space 53 between the mirrors and the glass window 44 (i.e., which is shown in FIG. 4) to be mainly nitrogen (not shown) and having an example thermal conductivity of 0.02 W/m-K.

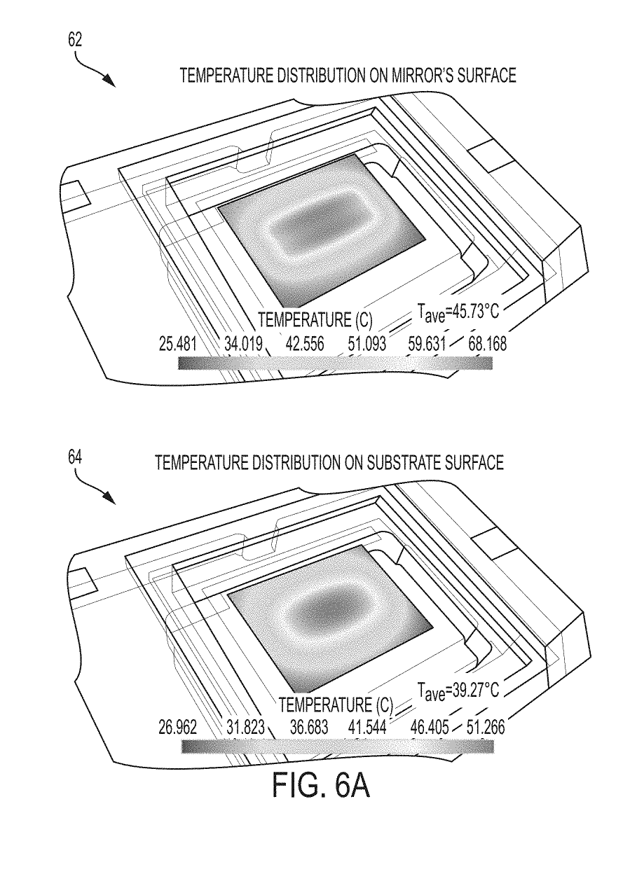

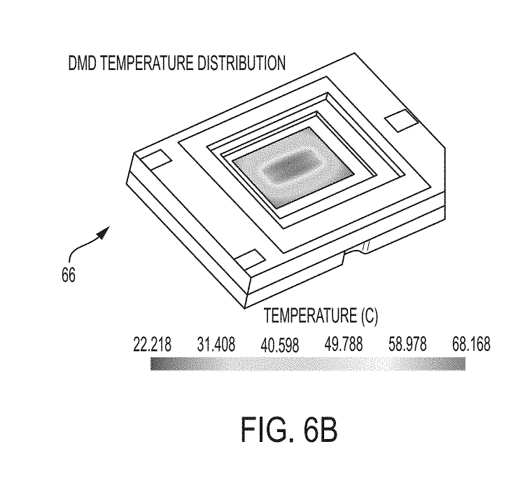

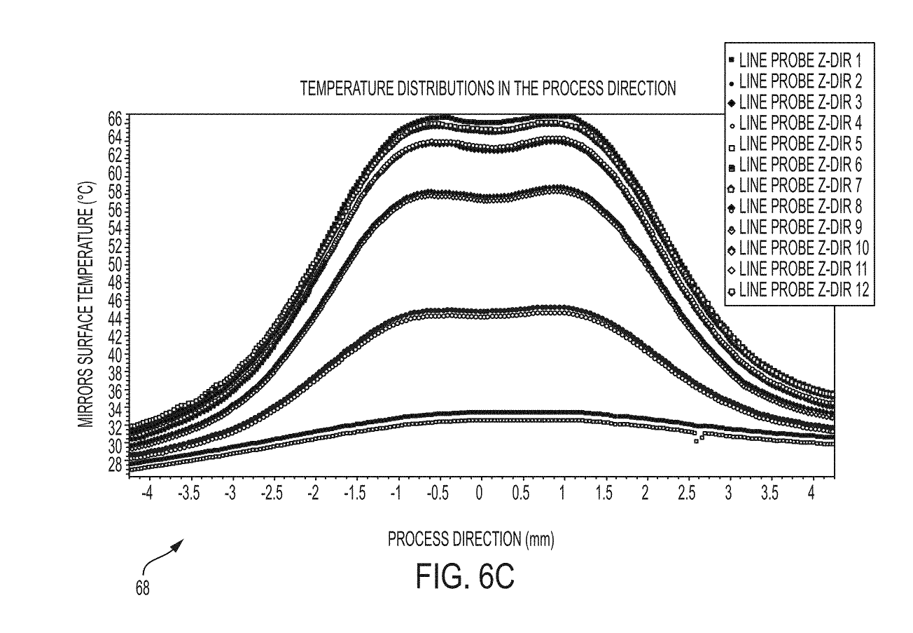

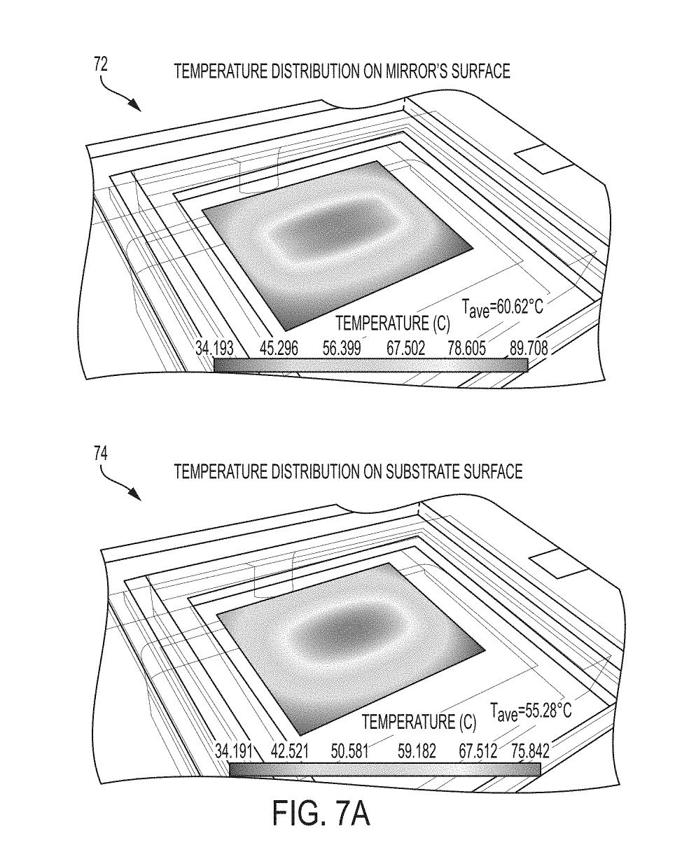

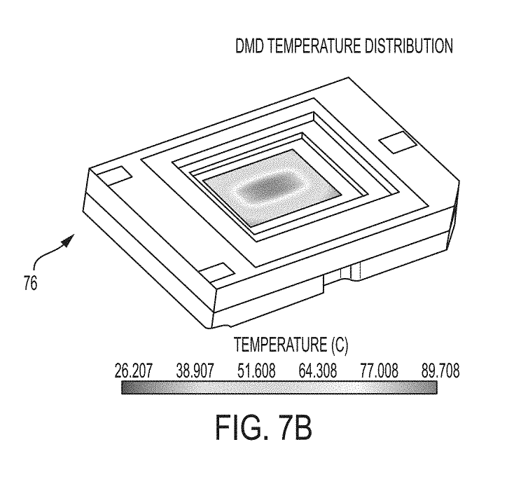

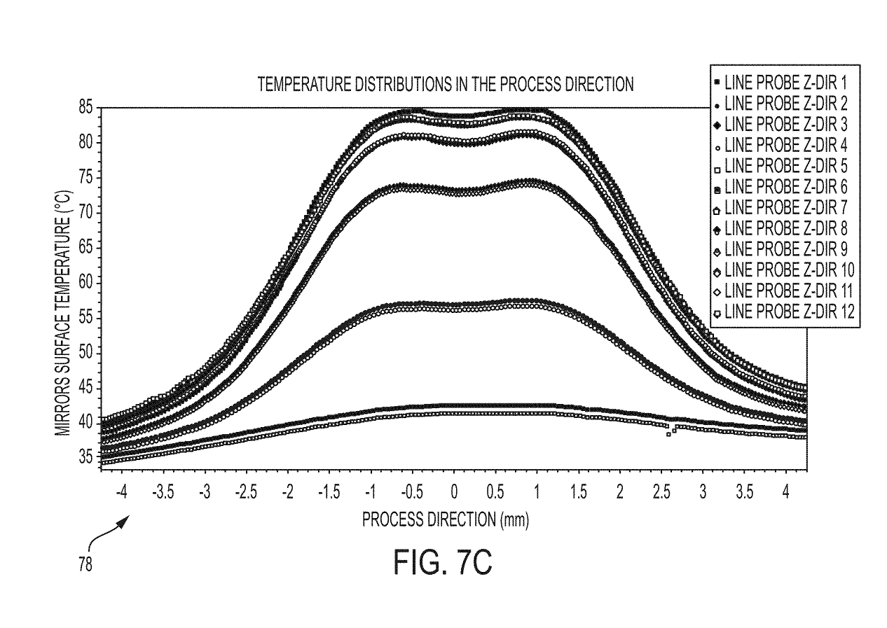

FIGS. 6A-6C to 7A-7C illustrate a group of pictorial diagrams and graphs depicting the temperature distribution of the mirrors and the substrate for the conditions shown in the figure, in accordance with an example embodiment. FIG. 6A, for example, illustrates a pictorial diagram 62 that depicts the temperature distribution of the mirror's surface and a pictorial diagram 64 that shows the temperature distribution on the substrate surface. FIG. 6B further depicts a pictorial diagram that demonstrates an example DMD temperature distribution. A graph 68 in FIG. 6C depicts example data indicative of temperature distribution on the mirror array surface in the process direction.

FIG. 6C thus shows the temperature distribution of the mirrors and the substrate for the conditions shown in the figure. The maximum temperature allowed at the mirrors surface is 70° C. for reliable operation. In this particular case, the maximum temperature was calculated to be 68.2° C. This temperature is for the conditions where the mirrors are in the ON state or the printing mode. In the “OFF state,” more energy is absorbed at the substrate and the temperature of the mirrors increase to 89° C., which is ˜20° C. above the maximum. FIGS. 7A-7C illustrate similar pictorial diagrams 72, 74, 76 and a graph 78, but with the mirrors in the “OFF state.”

The disclosed embodiments thus involve the use of an environmental control system (e.g., the disclosed cooling system) to reduce the local environmental operating temperature of the LIM to enhance heat transfer from the DMD, and reduce the environmental relative humidity to prevent condensation on components within the LIM such the DMD and the laser units. The environmental control system includes a fluid-to-air compact heat exchanger to reduce the temperature of the air to be delivered to the LIM. Before the cold air enters the LIM it passes through a Desiccant Dehumidification System (which will be described in greater detail herein) that dries the air to an even lower relative humidity. The amount of dehumidification required depends on the local environmental conditions and the DMD cooling flow temperature.

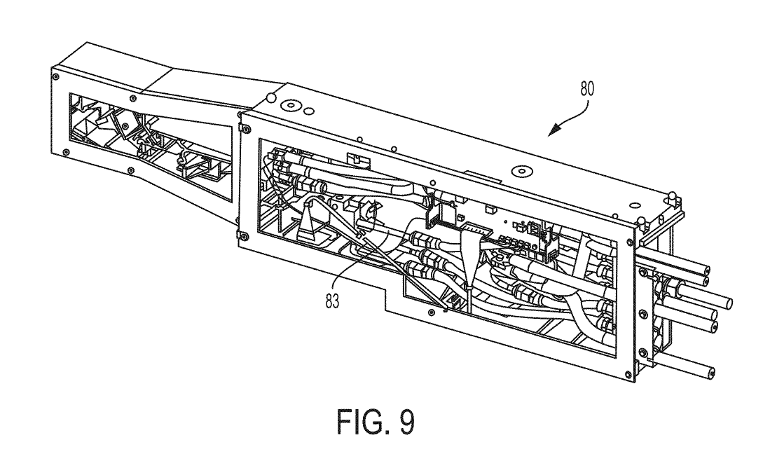

FIGS. 8-9 illustrate the layout of an LIM assembly 80 with and without the front cover 82, respectively, in accordance with an example embodiment. The front cover 82 is shown attached in FIG. 8, but removed in FIG. 9. That is, as shown in FIG. 9, an open space 83 reveals the components maintained by the LIM assembly 80.

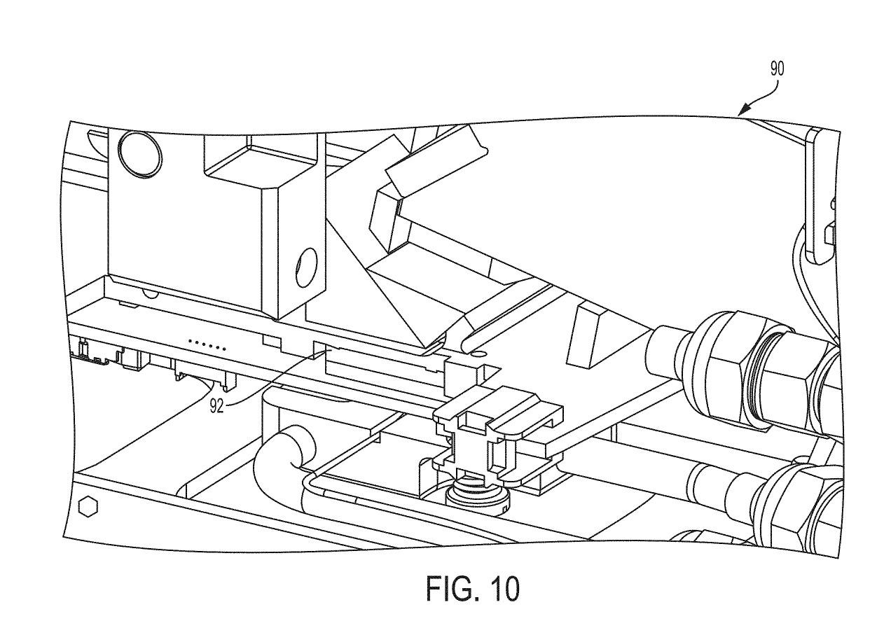

FIG. 10 illustrates a pictorial diagram 90 depicting the location of the DMD assembly 92 within the LIM assembly, in accordance with an example embodiment. The DMD assembly includes the DMD 14 with its various components such as the DMD housing, DMD epoxy, and so on illustrated previously.

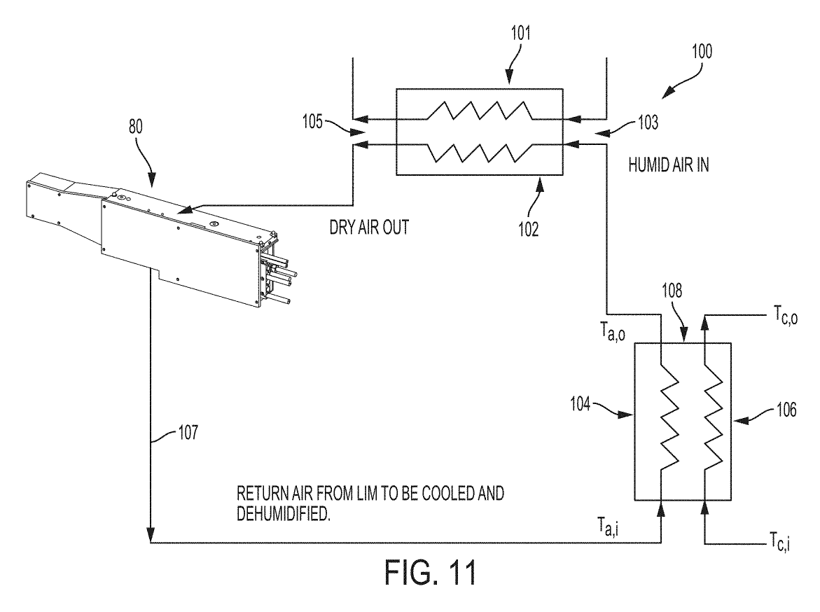

FIG. 11 illustrates a schematic diagram of an environmental control system 100 for temperature and humidity control, in accordance with an example embodiment. The control system can include a desiccant dryer 102 and a reactivation loop 101. Humid air enters at input 103 and dry air leaves at output 105 and is fed to the LIM assembly 80. Return air as shown at line 107 from the LIM assembly 80 (i.e., the “LIM”) is then cooled and dehumidified via an air loop 104 and a coolant loop 106 with respect to a compact type heat exchanger 108. The liquid-to-air heat exchanger 108 thus cools the air returning from the LIM and passes it through the desiccant dryer and returns it back to the LIM 80. For higher efficiency, the configuration shown in FIG. 11 can be implemented as a closed loop system.

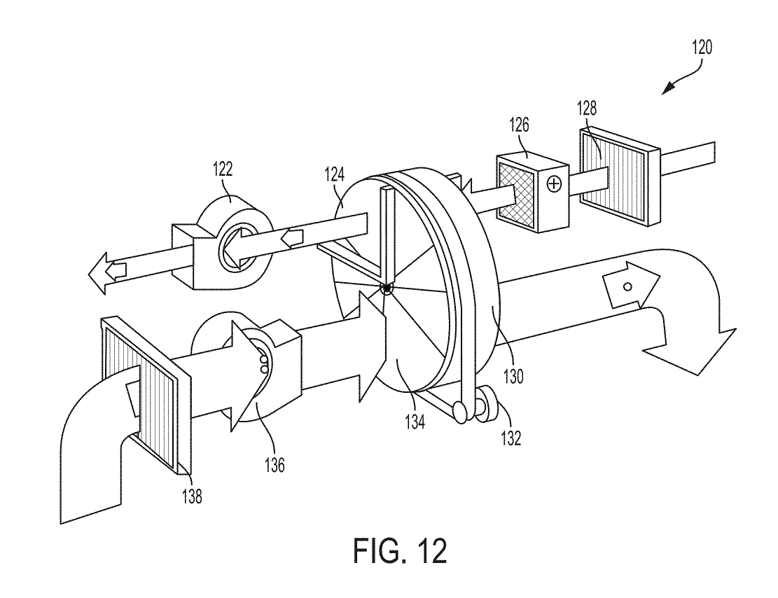

FIG. 12 illustrates a desiccant dehumidification system 120 (i.e., a desiccant dehumidifier) that can be implemented in accordance with an example embodiment. The desiccant dehumidification system 120 shown in FIG. 12 can include a pre-filter 128, a reactivation heater 126, a reactivation zone 124, a reactivation fan 122, a pre-filter 138, a process fan 136, a process zone 134, a geared motor 132, and a desiccant rotor 130. The air to be delivered to the LIM 80 thus passes through the desiccant to be dried. Filtered and heated air passes through a section of the desiccant material to remove the moisture and reactivate the desiccant media.

Based on the foregoing, it can be appreciated that a number of different example embodiments are disclosed herein. For example, in one embodiment an environmental control system can be implemented, which includes a heat exchanger, a desiccant dehumidifier, and a laser imaging module that includes one or more DMD's and one or more laser diode units. The heat exchanger can reduce the temperature of the air to be delivered to said laser imaging module. In such a system, prior to air entering said laser imaging module, said air passes through said desiccant dehumidifier, which dries said air to a lower relative humidity so as to reduce the environmental relative humidity to prevent condensation on critical components within said laser imaging module including the DMD (or DMD's) and the laser diode unit (or laser diode units).

In some example embodiments, the heat exchanger can be implemented as a fluid-to-air compact heat exchanger. The heat exchange preferably includes an air loop and a coolant loop. In some example embodiments, the desiccant dehumidifier includes a desiccant dryer and a reactivation loop. In general, the return air from said laser imaging module is cooled and dehumidified.

In some example embodiments, the desiccant dehumidifier can include a first pre-filter associated with a process fan that transmits air to a process zone having a geared motor and a desiccant rotor. Such a desiccant dehumidifier can also include a second pre-filter that is associated with a reactivation heater that provides air through said process zone to a reactivation zone for transmittal to a reactivation fan.

In some example embodiments, a cooling jacket is disposed below the DMD and the DMD is maintained by a housing (e.g., DMD housing), wherein said housing is configured to maintain a thermal pad.

In another example embodiment, an environmental control system can be implemented, which includes a heat exchanger and a desiccant dehumidifier, wherein said heat exchanger includes an air loop and a coolant loop. Such a system can further include a laser imaging module that includes at least one digital DMD and at least one laser diode unit, wherein said heat exchanger reduces a temperature of air to be delivered to said laser imaging module, wherein prior to air entering said laser imaging module, said air passes through said desiccant dehumidifier, which dries said air to a lower relative humidity so as to reduce the environmental relative humidity to prevent condensation on critical components within said laser imaging module including said at least one MID and said at least one laser diode unit.

In still another example embodiment, an environmental control method can be implemented that includes steps or operations such as providing a laser imaging module that includes at least one DMD and at least one laser diode unit, and reducing with a heat exchanger the temperature of air to be delivered to the laser imaging module, wherein prior to air entering the laser imaging module, the air passes through a desiccant dehumidifier, which dries the air to a lower relative humidity so as to reduce the environmental relative humidity to prevent condensation on critical components within the laser imaging module including the at least one DMD and the at least one laser diode unit.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

1. An environmental control system for a laser imaging system, said system comprising:
a liquid-to-air heat exchanger and a desiccant dehumidifier of a desiccant dehumidification system;
a DMD (Digital Micromirror Device) assembly that includes at least one DMD (Digital Micromirror Device) located on a circuit board in association with a cooling system that includes a cooling flow in tube and a cooling flow out tube, wherein said DMD assembly is associated with said liquid-to-air heat exchanger and said desiccant dehumidification system; and
a LIM (laser imaging module) that includes said at least one DMD and at least one laser diode unit, wherein said liquid-to-air heat exchanger reduces a temperature of air to be delivered to said laser imaging module, wherein prior to air entering said laser imaging module, said air passes through said desiccant dehumidifier, which dries said air to a lower relative humidity so as to reduce the environmental relative humidity to prevent condensation on critical components within said laser imaging module including said at least one DMD and said at least one laser diode unit, said at least one DMD further having a DMD window, and said DMD assembly including a DMD housing and a DMD socket and wherein said at least one DMD further includes a DMD substrate, a DMD substrate interface a mirrors-to-substrate gap, a DMD bezel and a DMD mirrors surface interface, such that said LIM combines a cooling fluid and low relative-humidity chilled air to cool said at least one DMD in said LIM and wherein before cold air enters said LIM, said cold air passes through said desiccant dehumidification system, which dries said cold air to a lower relative humidity.

2. The system of claim 1 wherein said liquid-to-air heat exchanger includes an air loop and a coolant loop implemented with respect to said cooling system and wherein said cooling system comprises a closed loop system.

3. The system of claim 3 wherein mainly nitrogen is located in said mirrors-to-substrate gap.

4. The system of claim 2 wherein said desiccant dehumidifier of said desiccant dehumidification system includes a desiccant dryer and a reactivation loop.

5. The system of claim 4 wherein return air from said LIM is cooled via said cooling system and dehumidified via said desiccant dehumidification system.

6. The system of claim 4 wherein said desiccant dehumidifier comprises a first pre-filter associated with a process fan that transmits air to a process zone having a geared motor and a desiccant rotor.

7. The system of claim 6 wherein said desiccant dehumidifier further comprises a second pre-filter that is associated with a reactivation heater that provides air through said process zone to a reactivation zone for transmittal to a reactivation fan.

8. The system of claim 7 wherein said cooling system further includes a cooling jacket disposed below said at least one DMD.

9. The system of claim 8 wherein said at least one DMD is maintained by said DMD housing, wherein said DMD housing is configured to maintain a thermal pad and wherein said cooling system further comprises said thermal pad.

10. An environmental control system for a laser imaging system, comprising:
a liquid-to-heat heat exchanger and a desiccant dehumidifier of a desiccant dehumidification system, wherein said heat exchanger includes an air loop and a coolant loop;
a DMD (Digital Micromirror Device) assembly that includes at least one DMD (Digital Micromirror Device) located on a circuit board in association with a cooling system that includes a cooling flow in tube and a cooling flow out tube, wherein said DMD assembly is associated with said liquid-to-air heat exchanger and said desiccant dehumidification system; and
a LIM (laser imaging module) that includes said at least one DMD and at least one laser diode unit, wherein said heat exchanger reduces a temperature of air to be delivered to said laser imaging module, wherein prior to air entering said laser imaging module, said air passes through said desiccant dehumidifier, which dries said air to a lower relative humidity so as to reduce the environmental relative humidity to prevent condensation on critical components within said laser imaging module including said at least one DMD and said at least one laser diode unit, said at least one DMD further having a DMD window, and said DMD assembly including a DMD housing and a DMD socket and wherein said at least one DMD further includes a DMD substrate, a mirrors-to-substrate gap, a DMD bezel and a DMD mirrors surface interface, such that said LIM combines a cooling fluid and low relative-humidity chilled air to cool said at least one DMD in said LIM and wherein before cold air enters said LIM, said cold air passes through said desiccant dehumidification system, which dries said cold air to a lower relative humidity.

11. The system of claim 10 wherein said liquid-to-air heat exchanger includes an air loop and a coolant loop implemented with respect to said cooling system and wherein said cooling system comprises a closed loop system.

12. The system of claim 11 wherein said desiccant dehumidifier includes a desiccant dryer and a reactivation loop.

13. The system of claim 11 wherein return air from said LIM is cooled via said cooling system and dehumidified via said desiccant dehumidification system.

14. The system of claim 11 wherein said desiccant dehumidifier comprises a first pre-filter associated with a process fan that transmits air to a process zone having a geared motor and a desiccant rotor.

15. The system of claim 14 wherein said desiccant dehumidifier further comprises a second pre-filter that is associated with a reactivation heater that provides air through said process zone to a reactivation zone for transmittal to a reactivation fan.

16. The system of claim 15 wherein said cooling system further includes a cooling jacket disposed below said at least one DMD.

17. The system of claim 16 wherein said at least one DMD is maintained by a housing, wherein said housing is configured to maintain a thermal pad, said cooling system including said thermal pad.

18. (canceled)

19. (canceled)

20. (canceled)
